(19) United States
(12) Patent Application Publication
(10) Pub. No.: US 2002/0092343 A1
(43) Pub. Date: Jul. 18, 2002

(54) Static gas seal pressure test fixture

(76) Inventor: Josef Sedy, Mt. Prospect, IL (US)

Correspondence Address: Josef Sedy, 1612 Greenwood Dr., Mount Prospect, IL, 60056, US

(21) Appl. No.: 09/759,885

(22) Filed: Jan. 16, 2001

(51) Int. Cl. G01M 3/02

(52) U.S. Cl. 73/37

(57) ABSTRACT

A static pressure test fixture for use with centrifugal compressor non-contacting seals, also called dry gas seals, typically assembled and applied in cartridge form. Subject fixture consists of only three major components of simple shape for easy fabrication and easy assembly with the dry gas seal cartridge. This is done on site near the centrifugal compressor so that dry gas seal cartridges can be pressure-tested just prior to installation in the compressor or on removal from the compressor to verify their static sealing function as well as measure static leakage at different pressures. Subject fixture is also designed to rectify some high leakage conditions.

This invention relates to testing devices for centrifugal compressor dry gas seals. Dry gas seals in cartridge form are sealing devices for centrifugal compressor rotating shafts where gaseous fluid is employed to generate pressure-induced forces between interacting face-type sealing elements, one being stationary and the other rotating. Testing devices for these dry gas seal cartridges are portable fixtures that are used with dry gas seal cartridges on compressor site to help determine the quality of static sealing function or in some cases to restore quality of static sealing function.

### BACKGROUND OF THE INVENTION

Non-contacting face seal assemblies are usually applied to high-speed, low-to-high pressure rotating equipment where the use of ordinary mechanical face seal assemblies with face contact would result in excessive generation of heat and face wear. Non-contacting operation avoids this undesirable face contact when the shaft is rotating above certain minimum speed, which is often called a lift-off speed.

As with ordinary contacting-type mechanical seal assemblies, a non-contacting face seal assembly typically consists of two sealing units oriented either in the same direction or in opposite directions. Most of the non-contacting face seal assemblies are oriented in the same direction, where gas under pressure can be prevented from leaking excessively across either of the sealing units in one axial direction and this direction will be the same for both units. Such a sealing arrangement is often called a tandem seal. The seal unit first exposed to the process gas pressure when installed in the compressor is called the main seal unit and the unit further away from process gas is called the back-up seal unit. Both sealing units are parts of a sealing assembly, called typically the dry gas seal cartridge. Subject seal cartridge when installed in the centrifugal compressor has rotary components fixed to and rotating with the compressor shaft and stationary components fixed to the compressor housing. To make sure that rotating and stationary components keep proper mutual position when out of the compressor, an additional component is typically installed at the one end of the cartridge seal not normally exposed to the process gas. That component is called a lock plate. Lock plate is removed when the cartridge seal is installed in the compressor and when rotating and stationary parts engage corresponding compressor components to keep the rotating and stationary parts in their proper mutual relationship.

Despite the use of the lock plate to keep the relationship of the internal seal components intact, it sometimes happens that either due to shocks during transportation from the manufacturing site to the compressor site or for other reasons the seal cartridge does not sufficiently restrict flow of process gas across the main seal unit when subjected to process gas pressure after being installed in the compressor or at any time after that event. As compressor is usually a valuable and critical piece of equipment, number of signals generated during the period of its operation is directed to safety circuits, protecting the compressor and its environment from harmful conditions. If the centrifugal compressor is equipped with above described dry gas seal cartridges, it usually has one at each shaft end. One of the most important safety signals is the process gas leakage magnitude existing at the dry gas seal cartridges, which is another way of expressing insufficient flow restriction. If the leakage is excessive, in other words seal cartridge does not sufficiently restrict flow of process gas, leaking gas raises pressure level and protective pressure switch located there engages the alarm circuit. As such operation with alarm activated is not permissible and usually quite dangerous, cause of the high leakage condition must be remedied. Such main seal unit is then not suitable for compressor operation and the whole dry gas seal cartridge must be removed again and replaced. As the installation and removal of the cartridge seal from the compressor is a labor-intensive operation, it is better to verify the sealing ability of the seal cartridge before it is installed in the compressor, because that way one assembly and disassembly operation is potentially avoided, resulting in considerable time and expense savings.

Similarly, if compressor is damaged by some external factor (stray piece of metal entering with gas stream, for example) and crashes, there may be no means of checking the condition of the dry gas seal cartridges. Again, verifying the static sealing ability before re-installation can confirm that seals were unaffected by the accident. Savings here is at the minimum the time and expense of sending the cartridge seals to the manufacturer and back.

### DESCRIPTION OF PRIOR ART

Prior art for tandem dry gas seals that are most often provided for customers in cartridge form can be found under variety of patents of Class 277, such as for example U.S. Pat. No. 4,290,611 FIG. 2, U.S. Pat. No. 4,889,348 FIG. 1, U.S. Pat. No. 5,039,113 FIG. 11 or U.S. Pat. No. 5,058,905 FIG. 3. Test equipment for these dry gas seals in cartridge form would be typically developed in-house by each individual seal manufacturer, apparently not patent-protected and rarely appearing in somewhat detailed rendition in public domain.

Typically, two basic types have been used. One type would accommodate two dry gas seal cartridges arranged face-to-face with their process sides, enclosed in a pressure barrel and installed over the drive shaft. Second type is for a single dry gas seal cartridge, thus more of a prior art to this invention. Fairly good representation of this latter type appeared on FIG. 9 and FIG. 10 in a 1998 paper by Takao Takeuchi et al. titled “Advanced Dry Gas Seal by the Dynamic Ion Beam Mixing Technique”27-th Turbomachinery Symposium Proceedings, Turbomachinery Laboratory, Texas A&M University, College Station, Tex. In this and other prior art found, there would be a pressure-bearing housing surrounding the dry gas seal cartridge along its entire length and a shaft installed within the bore of the dry gas seal cartridge.

### SUMMARY AND OBJECT OF THE INVENTION

As was shown in the previous paragraph, test equipment has been available which would determine static and dynamic sealing ability of the main or spare dry gas seals. Such test equipment has been often used to demonstrate to end users the sealing ability of the dry gas seals following their manufacture and assembly. Such test equipment is located at the seal manufacturing site and, therefore, not within easy reach of the end user. Subject test equipment is able to accommodate various seal sizes, range of pressures and speeds and able to verify sealing ability not only statically at standstill, but also dynamically during shaft rotation. It therefore includes a heavy test pod, the driver and driver controls, thus becoming quite universal but, at the same time, large and expensive. Most often it is permanently mounted and not easily transportable. Thus, there is little that typical end user can do on site if there are questions as to whether the set of dry gas seals may or may not be sealing properly.

To solve the above end user problem and according to this invention, on-site static dry gas seal cartridge pressure test fixture is presented. Such fixture first and foremost enables qualitative pressure tests of dry gas seal cartridges on compressor site, where a small gas pressure differential of some 50 psig from a convenient source of clean gas, such as for example highly filtered shop air, would be imposed onto the seal via the pressurization orifice by means of inlet valve adjustment and observing the pressure gauge. There will be an audible hissing sound if the seal faces are damaged, separated by clearance or static seals not sealing. Second, subject fixture can determine static leakage rate of the dry gas seal at different pressures, to be compared with the static leakage record established at the time of the seal manufacture. This is done for example by imposing somewhat higher pressure at the pressurization orifice than the measurement pressure. Once such pressure is reached, inlet valve is closed and pressure drop timed as it is indicated by the pressure gauge. Timing starts as the pressure gauge needle passes through one division above the measurement pressure and stops as it passes one division below measurement pressure. Using with typically sufficient accuracy the basic ideal gas relationships, the leakage rate is then calculated from the above time measurement, trapped volume within the seal and fluid properties. Third, should the seal at hand exhibit high leakage condition, rapid pressure imposition while the dry gas seal cartridge is installed in the fixture can often remedy the high leakage condition as per the above qualitative test and reestablish normal static sealing leakage rate. Thus, in case of compressor accident, within a very short time span and with very little expense both main and spare dry gas seals can be tested for normal or abnormal behavior and measures then taken to re-install only dry gas seal cartridges with such static leakage values that would point to acceptable static and dynamic leakage values when compressor is put back on line. Proximity of the test fixture according to this invention to the centrifugal compressor avoids risk, cost and time delays shipping dry gas seal cartridges back to the seal manufacturer for test or repair.

Another version of the above test fixture is one where two pressurization orifices are used, one on the process side of the seal, the other between the two static seals at the outer periphery of the dry gas seal cartridge. This is useful for testing either of the two sealing units rather than the process side unit only per previous version. Test procedure for the process side unit is similar to the previous with the second pressurization orifice vented to atmosphere. Test procedure for the bearing side unit is done with both sealing units under full pressure and venting closed, again following previously described test sequence, making sure that there is an escape path for seal leakage at the bearing side of the seal.

The test fixture according to this invention consists of only three main parts. One is a test adapter, having the cup-like appearance, where the rim extension can be integral with the bottom or bolted on. Second is a disc-like support plate. Third is the bolting, connecting the other two. Fixture clamps over the fully assembled dry gas seal cartridge with one or more bolts located within the bore of the dry gas seal cartridge. Thus, it can be easily manufactured and quickly installed over the dry gas seal as well as quickly removed after the test is completed.

### BRIEF DESCRIPTION OF THE DRAWINGS

FIG. 1 is a cross-sectional view of a static seal test fixture assembled with the dry gas seal cartridge, constructed in accordance with this invention, taken along the longitudinal axis thereof.

FIG. 2 is a cross-sectional view of another embodiment of the static seal test fixture assembled with the dry gas seal cartridge, constructed in accordance with this invention, taken along the longitudinal axis thereof.

### DESCRIPTION OF THE PREFERRED EMBODIMENTS

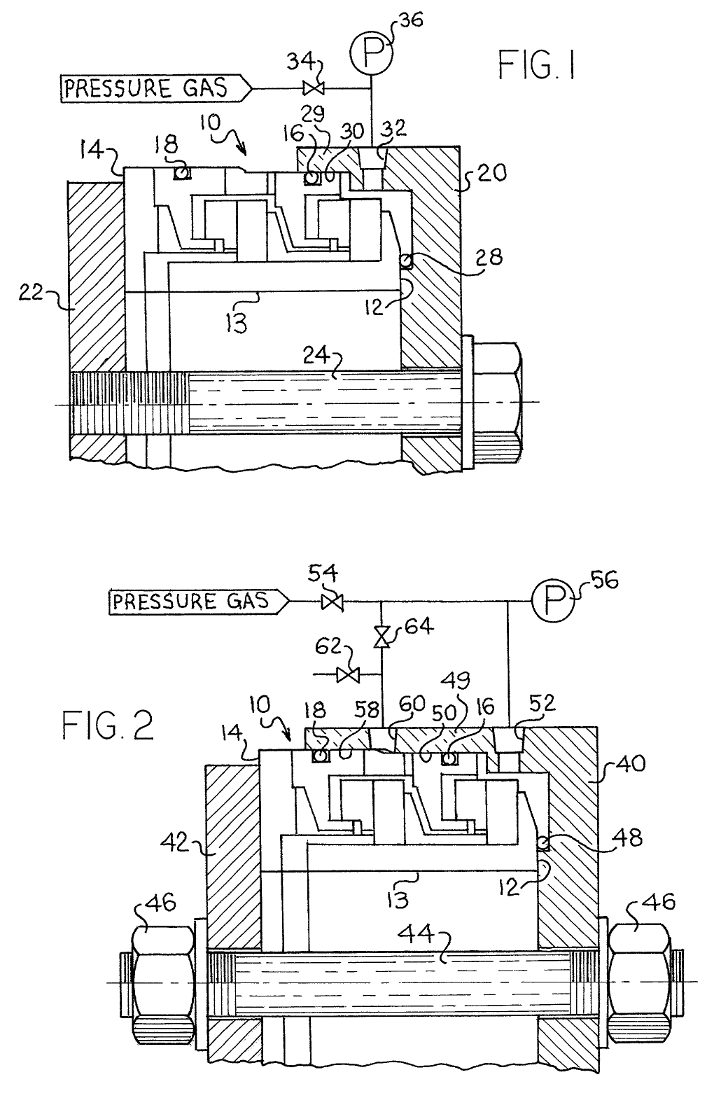

Referring first to FIG. 1, there is shown the invention and its environment. This environment comprises a seal cartridge 10, which has a process side surface 12, inner surface 13 and a bearing side surface 14. The seal cartridge 10 also has at its outer periphery a process side O-ring 16 and an atmospheric side O-ring 18. The seal cartridge 10 is axially clamped between a test adapter 20 and a support plate 22 by a threaded bolt 24 engaging the support plate 22. Embodiments are also envisioned (not shown) where the threaded bolt 24 would thread into the test adapter 20 or embodiments where threaded rod and nut combination would be used in place of the bolt 24. The test adapter 20 bears against the process side surface 12 while the support plate 22 bears against the atmospheric side surface 14. The space between the process side surface 12 and the test adapter 20 is sealed by means of a face O-ring 28. The test adapter 20 has an axial extension 29 with an inner cylindrical surface 30 in sealing engagement with the process side O-ring 16. The test adapter 20 has an opening 32, fabricated to pass through the wall of the test adapter 20 between the areas of its contact with the process side O-ring 16 and the face O-ring 28. The opening 32 is connected to the source of pressure gas through a cut-off valve 34 and to a pressure gauge 36.

FIG. 2 shows another embodiment of the invention. This embodiment again comprises a seal cartridge 10, which has a process side surface 12, inner surface 13 and a bearing side surface 14. The seal cartridge 10 has at its outer periphery a process side O-ring 16 and an atmospheric side O-ring 18. The seal cartridge 10 is axially clamped between a test adapter 40 and a support plate 42 by a threaded rod 44 engaging one threaded nut 46 at each end. Embodiments are also envisioned (not shown) where similarly to FIG. 1 the threaded rod 44 would thread into the support plate 42, embodiments where threaded connection would be between threaded rod 44 and the test adapter 40 or embodiments where bolt would be used instead of threaded rod—nut combination. The test adapter 40 bears against the process side surface 12 while the support plate 42 bears against the bearing side surface 14. The space between the process side surface 12 and the test adapter 40 is sealed by means of a face O-ring 48. The test adapter 40 has an axial extension 49 with a first inner cylindrical surface 50 in sealing engagement with the process side O-ring 16 and a second inner cylindrical surface 58 in sealing engagement with the bearing side O-ring 18. The test adapter 40 has a first threaded opening 52, fabricated to pass through the wall of the test adapter 40 between the areas of its contact with the process side O-ring 16 and the face O-ring 48. The test adapter 40 has also a second threaded opening 60, fabricated between the first inner cylindrical surface 50 and the second inner cylindrical surface 58. The first threaded opening 52 is connected to the source of pressure gas through a first cut-off valve 54 and to a pressure gauge 56. There is also a connection through a second cut-off valve 64 between the first threaded opening 52 and the second threaded opening 60. One side of a third cut-off valve is also connected to the second threaded opening 60 while its other side is open to atmosphere.

I claim:

1. A test device for imposing and varying fluid pressure on a dry gas seal cartridge approximately in shape of a hollow cylinder, said dry gas seal cartridge comprising: a process side end, a process side outer static seal, a bearing side end, a bearing side outer static seal and a shaft bore, said dry gas seal cartridge being typically applied to seal turbomachinery shafts, said test device comprising:
a test adapter mounted adjacent said process side end of said dry gas seal cartridge for its pressurization,
a support plate mounted adjacent said bearing side end of said dry gas seal cartridge for supporting axial forces due to pressurization effects,
a connecting means carrying said axial forces from said test adapter to said support plate through said shaft bore of said dry gas seal cartridge,
a static sealing means, sealing the space between said process side end and said test adapter.
said test adapter comprising:
an axial extension to hold an inner cylindrical surface to provide a sealing contact with said process side outer static seal,
a pressurization orifice for injection of pressurized fluid.

2. Device according to claim 1, where said static sealing means is an O-ring.

3. Device according to claim 1, where said connecting means is at least one threaded stud, said stud comprising at least one threaded nut.

4. Device according to claim 1, where said connecting means is at least one bolt.

5. Device according to claim 2, where said connecting means is at least one threaded stud, said stud comprising at least one threaded nut.

6. Device according to claim 2, where said connecting means is at least one bolt.

7. A test device for imposing and varying fluid pressure on a dry gas seal cartridge approximately in shape of a hollow cylinder, said dry gas seal cartridge comprising: a process side end, a process side outer static seal, a bearing side end, a bearing side outer static seal and a shaft bore, said dry gas seal cartridge being typically applied to seal turbomachinery shafts, said test device comprising:
a test adapter mounted adjacent said process side end of said dry gas seal cartridge for its pressurization,
a support plate mounted adjacent said bearing side end of said dry gas seal cartridge for supporting axial forces due to pressurization effects,
a connecting means carrying said axial forces from said test adapter to said support plate through said shaft bore of said dry gas seal cartridge,
a static sealing means, sealing the space between said process side end and said test adapter.
said test adapter having an axial extension comprising:
first inner cylindrical surface to provide sealing contact with said process side outer static seal,
second inner cylindrical surface to provide sealing contact with said bearing side outer static seal,
second pressurization orifice for injection of pressurized fluid, located between said first inner cylindrical surface and said second inner cylindrical surface,
said test adapter having a pressurization orifice for injection of pressurized fluid.

8. Device according to claim 7, where said static sealing means is an O-ring.

9. Device according to claim 7, where said connecting means is at least one threaded stud, said stud comprising at least one threaded nut.

10. Device according to claim 7, where said connecting means is at least one bolt.

11. Device according to claim 8, where said connecting means is at least one threaded stud, said stud comprising at least one threaded nut.

12. Device according to claim 8, where said connecting means is at least one bolt.
